(19) United States
(12) Patent Application Publication
(10) Pub. No.: US 2010/0218719 A1
(43) Pub. Date: Sep. 2, 2010

(54) PAINT ROLLER CAGE AND COVER

(76) Inventor: Pascal Belley, Quebec (CA)

Correspondence Address: OGILVY RENAULT LLP, 1, Place Ville Marie, SUITE 2500, MONTREAL, QC, H3B 1R1, CA

(21) Appl. No.: 12/680,793

(22) PCT Filed: Oct. 1, 2008
(86) PCT No.: PCT/CA08/01744

§ 371 Date: Mar. 30, 2010

(30) Foreign Application Priority Data
Oct. 1, 2007 (US) 60976493

(51) Int. Cl. B05C 17/02; B05C 21/00

(52) U.S. Cl. 118/258

(57) ABSTRACT

A roller painting kit comprising a roller cage adapter engageable over a roller section of a paint roller and having a substantially continuous cylindrical outer surface when engaged over the roller section, and a flexible roller cover insertable over the roller cage adapter, the roller cover being flexible so it can be rolled onto itself for storage. The roller cage adapter is radialy expandable to provide retention action between the roller cover and roller cage in an operative position.

### CROSS-REFERENCE TO RELATED APPLICATIONS

This application claims priority under 35 USC §119(e) of U.S. provisional patent application 60/976,493 filed on Oct. 1, 2007, the specification of which is hereby incorporated by reference.

### FIELD OF THE INVENTION

The invention relates to paint rollers and, more particularly, to a paint roller cage and a paint roller cover.

### DESCRIPTION OF THE PRIOR ART

Paint rollers permit to apply relatively quickly and economically coatings such as paint and stain. Nearly every paint roller in commercial use includes a frame which terminates at one end in a handle and, at the other end, in a core and cover support rod having a core (or cage) supporting frame extending radially. The core supporting frame typically includes spaced apart and longitudinally extending rods. A rigid cylindrical core having a roller cover permanently mounted thereto is typically removably receivable on the support rod and the core supporting frame. The roller support rod and the core and cover assembly are thus typically assembleable and disassembleable components. Therefore, once used, the core and cover assembly is removed from the roller support rod and either washed and stored or thrown away.

For storing and transport purposes, the rigid core and cover assemblies are relatively bulky components. Moreover, when thrown away, they are not ecologically friendly.

### BRIEF SUMMARY OF THE INVENTION

It is therefore an aim of the present invention to address the above mentioned issues.

According to a general aspect, there is provided a paint roller cage for receiving a paint roller cover thereto. The paint roller cage comprises: a barrel member having an outer surface, a length corresponding substantially to a length of the paint roller cover, and being movable between a contracted state for engaging and disengaging the paint roller cover from the outer surface and an expanded state securing the paint roller cover to the barrel member.

According to another general aspect, there is provided a roller painting kit, comprising: a cylindrical paint roller cage movable between a storage configuration and an operative configuration and having a plurality of adjacent cage sections defining a substantially cylindrical barrel member in the operative configuration; and a roller cover slidable over the paint roller cage in the storage configuration and secured over the paint roller cage in the operative configuration.

According to another general aspect, there is provided a flexible paint roller cover mountable to a paint roller cage, comprising a cylindrical cover element defining a cylindrical channel for receiving therein the paint roller cage, the roller cover being flexible along at least one of a longitudinal axis and a transversal axis when disengaged from the paint roller cage.

According to another general aspect, there is provided a roller cover adapter for a paint roller having a roller section. The roller cover adapter comprises: a barrel member securable to the roller section of the paint roller and configurable in a storage configuration allowing to slide a roller cover over an outer surface of the barrel member and remove the roller cover from the outer surface and an operative configuration securing the roller cover to the outer surface, the barrel member having a substantially continuous and cylindrical outer surface in the operative configuration for supporting the paint roller cover along its length.

According to a further general aspect, there is provided a roller painting kit, comprising: a roller cage adapter engageable over a roller section of a paint roller and having a substantially continuous and cylindrical outer surface when engaged over the roller section; and a flexible roller cover insertable over the roller cage adapter and including a cylindrical cover element defining a cylindrical channel for receiving therein the roller cage adapter, the roller cover being flexible along at least one of a longitudinal axis and a transversal axis when disengaged from the roller cage adapter, the roller cage adapter providing a substantially continuous support to the roller cover when inserted therein.

In this specification, the term “paint” is intended to mean “liquid coatings” such as and without being limitative paint, lacquer, varnish, base coats, clear coats, primers, enamel, wood finishes, adhesive, stains, etc. It encompasses a mixture of resin, pigment, and a suitable liquid vehicle that is reasonably fluid, and provides a thin and adherent coating when applied to a substrate.

### BRIEF DESCRIPTION OF THE DRAWINGS

FIG. 1 is a perspective view of a paint roller in accordance with an embodiment wherein a roller cover is removed from a roller cage;

FIG. 2 is a perspective view of the paint roller shown in FIG. 1 with an exploded view of the paint roller cage in accordance with an embodiment;

FIG. 3 is a perspective view of a cage section of the paint roller cage shown in FIG. 2;

FIG. 4 is a side elevation view of the cage section shown in FIG. 3;

FIG. 5 is a front elevation view of the cage section shown in FIG. 3; and

FIG. 6 is bottom plan view of the cage section shown in FIG. 3;

FIG. 7 is a perspective view of a proximal end cap of the paint roller shown in FIG. 1;

FIG. 8 is a side elevation view of the proximal end cap shown in FIG. 7;

FIG. 9 is a front elevation view of the proximal end cap shown in FIG. 7;

FIG. 10 is a perspective view of a distal end cap of the paint roller shown in FIG. 1;

FIG. 11 is a side elevation view of the distal end cap shown in FIG. 10;

FIG. 12 is a front elevation view of the distal end cap shown in FIG. 10;

FIG. 13 is a cross-sectional view of a cover and cage portion of the paint roller shown in FIG. 1, wherein the roller cover is mounted to the roller cage and the roller cage is configured in a contracted configuration;

FIG. 14 is a cross-sectional view of a cover and cage portion of the paint roller shown in FIG. 1, wherein the roller cover is mounted to the roller cage and the roller cage is configured in an expanded configuration;

FIG. 15 is a cross-sectional view, enlarged and fragmented, of a cover and cage portion of the paint roller shown in FIG. 1 in the contracted configuration showing the proximal and the distal ends;

FIG. 16 is a cross-sectional view, enlarged and fragmented, of a cover and cage portion of the paint roller shown in FIG. 1 in the expanded configuration showing the proximal and the distal ends;

FIG. 17 is a perspective view of a paint roller in accordance with another embodiment wherein a roller cover is removed from a roller cage;

FIG. 18 is a perspective view of the paint roller cage shown in FIG. 17 wherein cage sections have been removed;

FIG. 19 is a perspective view of the paint roller shown in FIG. 17 wherein all the cage sections have been removed;

FIG. 20 is a perspective view of a cage section of the paint roller cage shown in FIG. 17;

FIG. 21 is a side elevation view of the paint roller cage shown in FIG. 17 in the contracted configuration;

FIG. 22 is a cross-sectional view of the paint roller cage shown in FIG. 17 in the expanded configuration;

FIG. 23 is a cross-sectional view of the paint roller cage shown in FIG. 17 including only one cage section and configured in the contracted configuration;

FIG. 24 is a side elevation view of the paint roller cage shown in FIG. 17 including only one cage section and configured in the expanded configuration;

FIG. 25 is a perspective view of a flexible cover in accordance with an embodiment;

FIG. 26 is a perspective view of the flexible cover shown in FIG. 25, partly folded along a transversal axis;

FIG. 27 is a cross-sectional view of the flexible cover shown in FIG. 25; and

FIG. 28 is a perspective view of a paint roller cage adapter for traditional paint roller cages in accordance with an embodiment.

It will be noted that throughout the appended drawings, like features are identified by like reference numerals.

### DETAILED DESCRIPTION

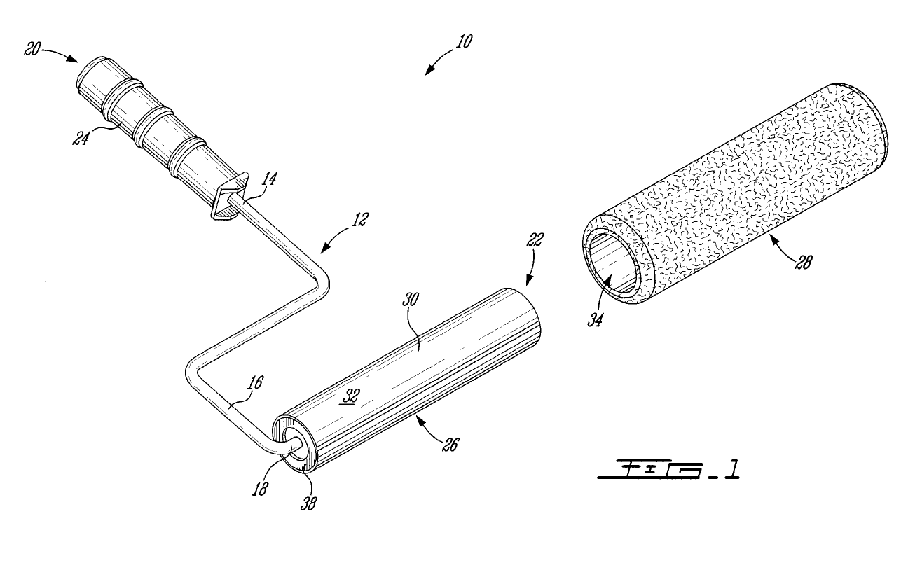

Referring now to the figures, and more particularly referring to FIG. 1, it will be seen a paint roller 10 including a support frame 12 having a handle section 14, an extension section 16, and a roller section 18. The support frame 12 extends between a handle end 20 and a roller end 22, opposite to the handle end 20. A handle 24 is mounted over the handle section 14 of the support frame 12. A paint roller cage 26 and a paint roller cover 28 are mounted over the roller section 18 of the support frame 12. The extension section 16 extends between the handle section 14 and the roller section 18.

The roller cage 26 includes a cylindrical barrel member 30 with a substantially continuous outer surface 32, as it will be described in more details below. The roller cover 28 defines a cylindrical channel 34 and, in an embodiment, is flexible along a longitudinal axis and a transversal axis. The roller cage 26 is insertable in the channel 34 of the roller cover 28 for painting purposes. Thus, the substantially continuous outer surface 32 of the cage 26 provides a substantially continuous support to the roller cover 28 when mounted thereto.

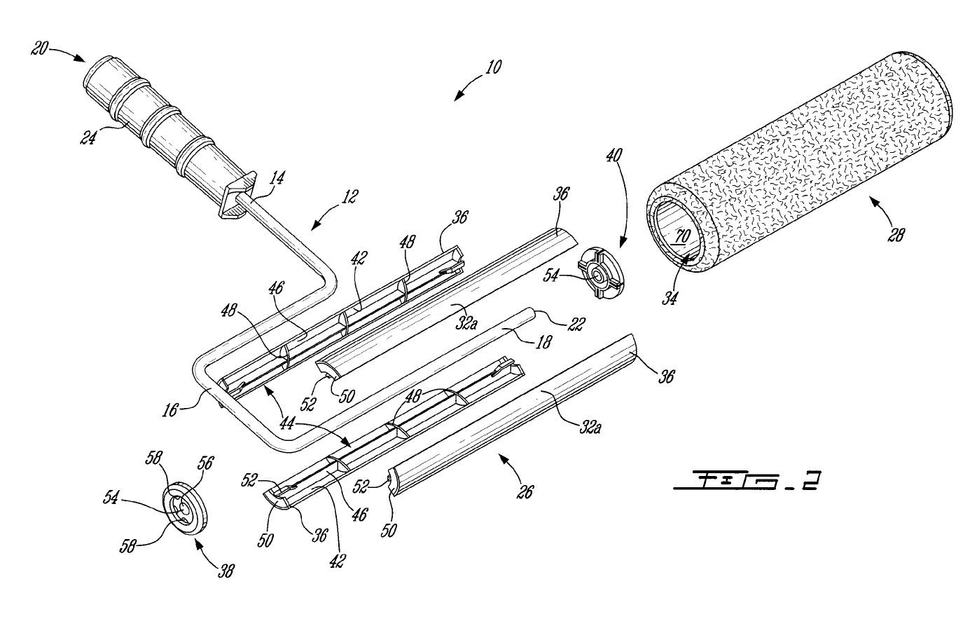

Now referring to FIG. 2, an embodiment of the cylindrical barrel member 30 of the roller cage 26 will be described in more detail. The barrel member 30 has four longitudinally extending cage sections 36, a proximal end cap 38, and a distal end cap 40. The proximal end cap 38 is insertable over the support rod 12, proximate to the extension section 16, and the distal end cap 40 is also insertable over the support rod 12 proximate to the roller end 22, opposite to the proximal end cap 38. Both end caps 38, 40 connect the four cage sections 36 together to define the barrel member 30 with the cylindrical outer surface 32.

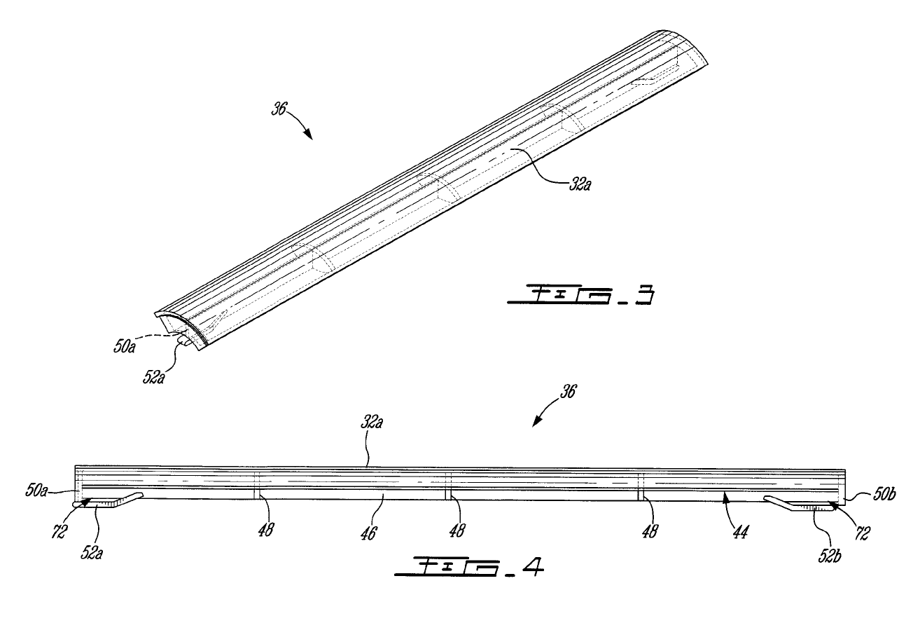

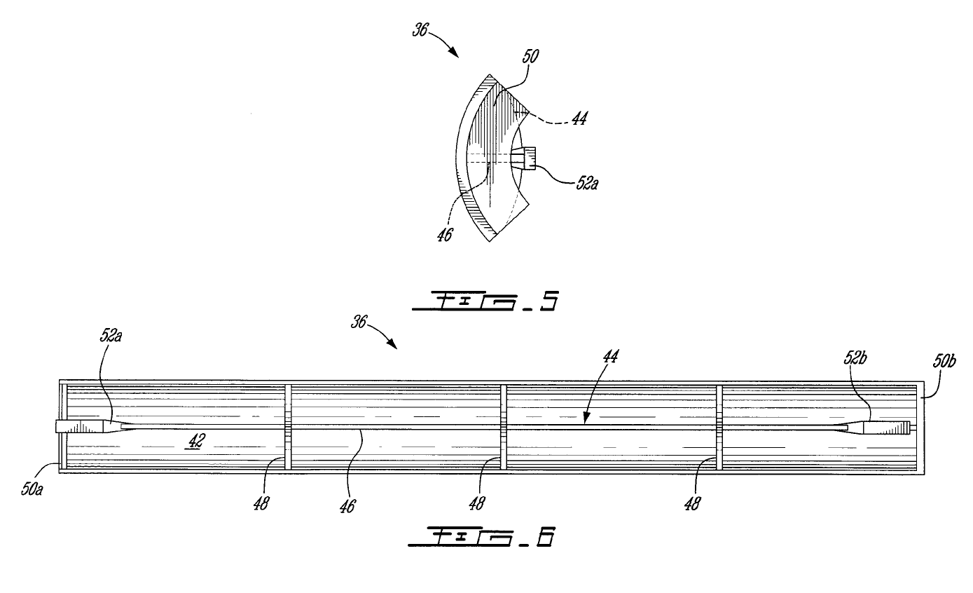

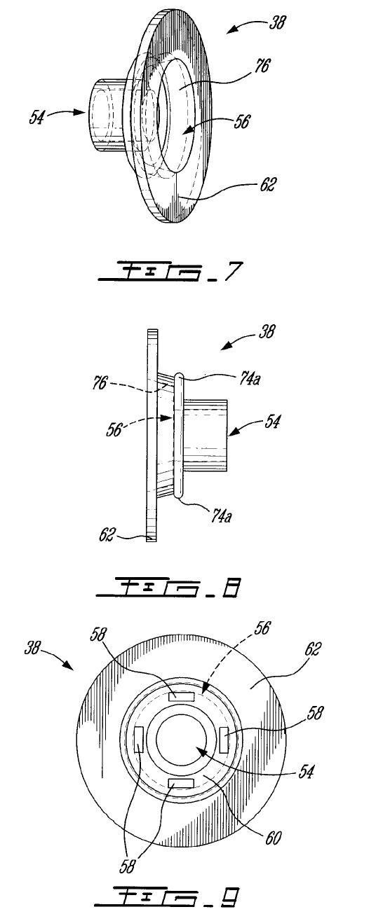

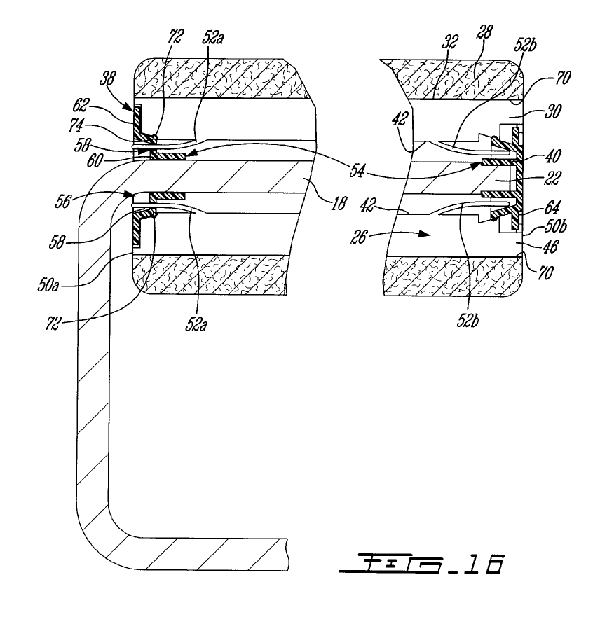

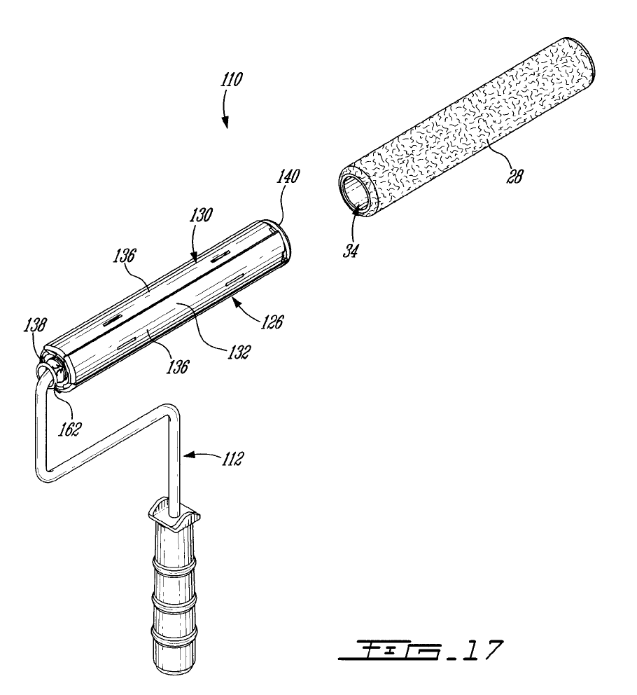

Referring to FIGS. 3 to 6, the cage sections 36 will be described in more details. Each cage section 36 has an outer surface 32a, an opposite inner surface 42, and a web 44 protruding inwardly from the inner surface 42 to provide structural rigidity to the cage section 36. The web 44 includes a longitudinally extending central ridge 46 and a plurality of transversally extending ridges 48. Each cage section 36 has two opposite lateral walls 50 both having a quarter of an annular shape. The lateral wall 50a, proximate to the proximal end cap 38, is spaced from the edge of the cage section 36, thereby defining an annular cavity 49 when the four cage sections 36 are assembled together. The purpose of the cavity 49 (FIG. 14a) will be described in more details below. The lateral wall 50b, proximate to the distal end cap 40, extends inwardly from the edge of the cage section 36. As mentioned above, the lateral walls have a quarter of an annular shape. When the four cages sections 36 are assembled together to define the barrel member 30, a central opening 51 is defined centrally (FIG. 13). The central opening 51 extends from the distal end cap 40 to the proximal end cap 38. The cavity 49, defined by the lateral wall 50a, is adjacent to the central opening 51 and is concentric therewith.

Two tabs 52 extend longitudinally from each central ridge 46: a first tab 52a extends towards the proximal end cap 38 and a second tab 52b extends towards the distal end cap 40. Each tab 52 has an arcuate shape. The proximal end tab 52a extends outwardly of the lateral walls 50a, in the longitudinal direction of the cage section 36. On the opposite, the distal end tab 52b does not extend outwardly of the lateral walls 50b. The purpose of the tabs 52 will be described in more details below.

The central ridge 46 has two engaging grooves 72 (or female members) defined therein. The grooves 72 are located under a corresponding tab 52. The grooves 72 are designed to engage a corresponding protruding or male member, as it will be described in more details below.

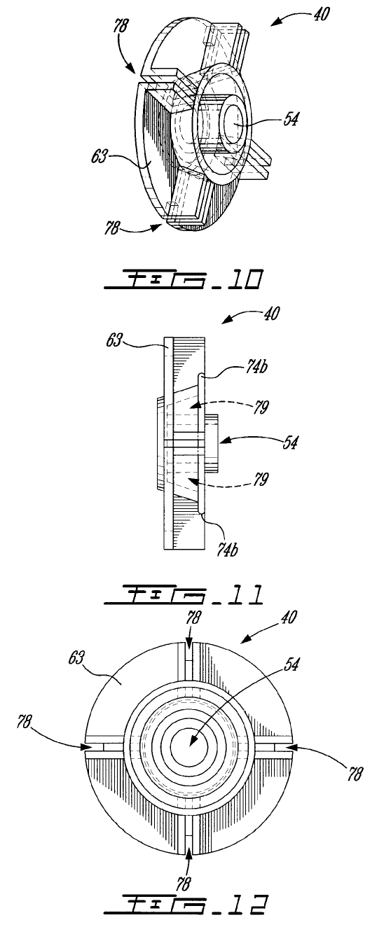

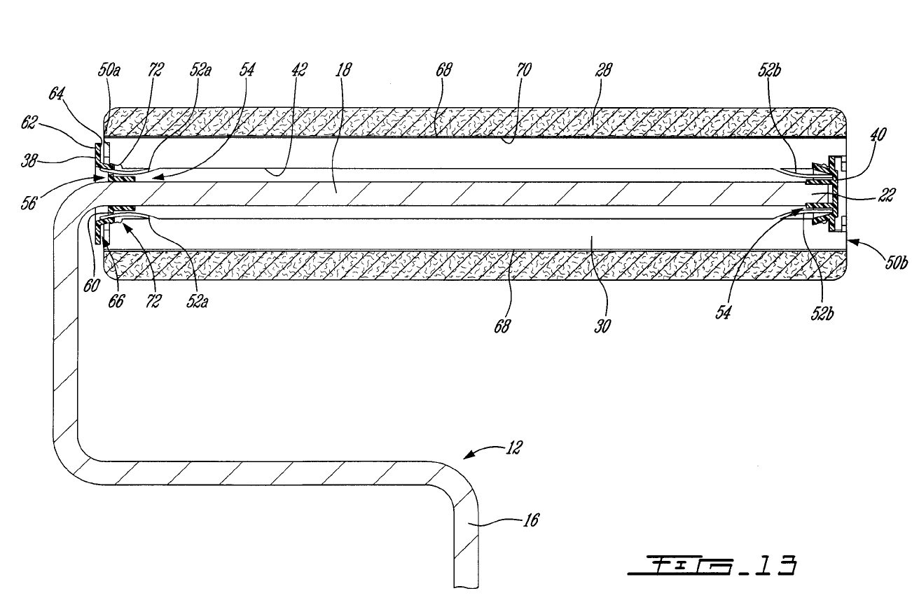

Referring back to FIG. 2, it will be seen that the proximal and distal end caps 38, 40 are designed to assemble the cage sections 36 together to define the cylindrical barrel member 30. Referring next to FIGS. 7 to 12, it will be seen that each end cap 38, 40 has a cylindrical channel 54 defined centrally therein. The support rod 12 is insertable in the channel 54 to mount to end caps 38, 40 thereto.

The proximal end cap 38 also includes a circular depression 56 surrounding the cylindrical channel 54, as shown in FIGS. 7 to 9. The bottom wall 60 of the depression 56 includes four tab openings 58 in which the proximal tabs 52a of the cage sections 36 are slidably insertable. The annular peripheral wall 62 circumvents outwardly the depression 56 and the cylindrical channel 54. The proximal end cap 38 also includes an annular protruding member 74a extending outwardly from the lateral walls 76 of the end cap 38, the purpose of which will be described in more details below.

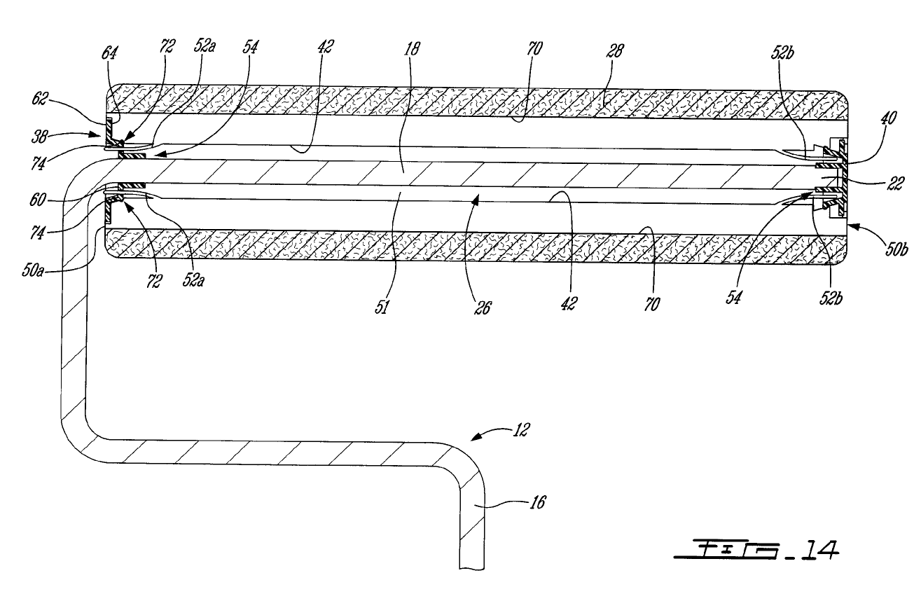

The distal end cap 40 also includes a peripheral wall 63, as shown in FIGS. 10 to 12, with four radially extending slots 78, and four cavities 79 (only two are shown) in which the distal tabs 52b of the roller sections 36 are insertable.

As it will be described in more details below, in the operative configuration of the paint roller, the end caps 38, 40 are disposed and fitted in the ends of the roller sections 36 for preventing paint from entering the hollow interior of the barrel member 30 or between the outer surface 32 of the cage 26 and an inner wall 70 of the roller cover 28.

Referring now to FIGS. 13 to 16, the roller cage 26 with the roller cover 28 mounted thereto will be described. The support rod 12 extends centrally through the roller cage and cover assembly. The roller cover 28 extends outwardly and surrounds the roller cage 26, mounted to the support rod 12. As shown, the support rod 12 is inserted in the cylindrical channels 54 of both end caps 38, 40. The proximal end cap 38 is mounted outwardly of the cage sections 36 while the distal end cap 40 is mounted inwardly of the cage sections 36. The tabs 52a, 52b, as male members, are engaged in a respective tab opening 58, or a respective cavity 79, as female members, in one of the end caps 38, 40. The purpose of which will be described in more details below.

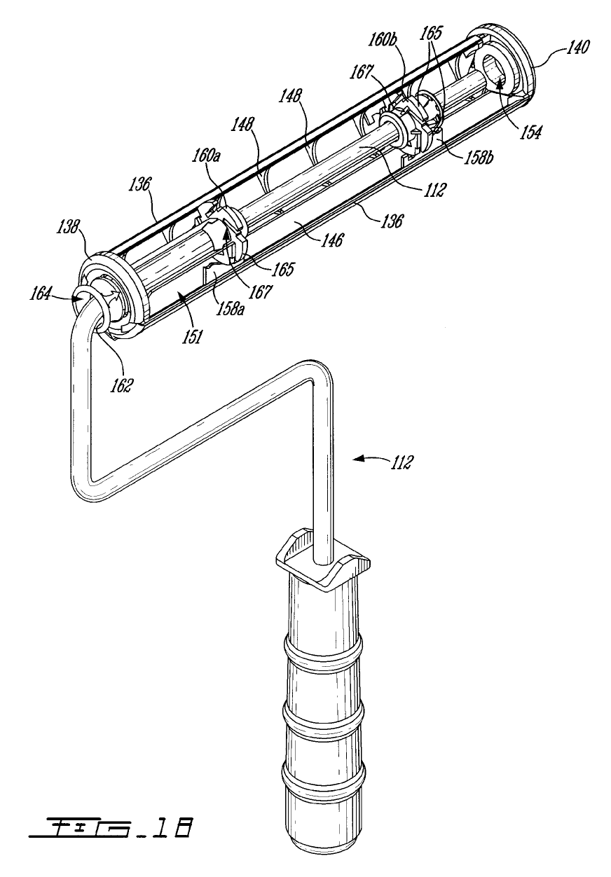

The roller cage 26 is movable or configurable in two configurations, more particularly, a contracted configuration (FIGS. 13 and 15) and expanded configuration (FIGS. 14 and 16). In the contracted configuration (or storage configuration), a narrow cylindrical free space 68 is defined between the outer surface 32 of the roller cage 26 and the inner wall 70 of the roller cover 28, i.e. the outer diameter of the barrel member 30 is smaller than the diameter of the cylindrical channel 34. An annular space 66 is defined between the inner surface 64 of the proximal end cap peripheral wall 62 and the lateral wall 50a of the roller cage 26. Therefore, the roller cover 28 can be easily slid in and slid out over the roller cage 26 in the contracted configuration. The distal end 40 is spaced-apart from the lateral wall 50b of the roller cage 26. The tabs 52a protrude slightly outwardly in the tab openings 58. Therefore, the roller cage 26 can be more deeply engaged over the support rod 12 by pushing the roller cage 26 in a configuration where the inner surface 64 of the proximal end cap peripheral wall 62 abuts the lateral wall 50a of the roller cage 26, and the distal end cap 40 is aligned with the lateral wall 50b. In that second configuration, the tabs 52 protrude more outwardly in the tab openings 58 as shown in FIGS. 14 and 16. In the contracted configuration, the tabs 52b abut the bottom wall of the cavities 79 (FIG. 15) and the peripheral wall 63 of the distal end cap 40 is spaced-apart from the lateral wall 50b. In the expanded configuration, the tabs 52b are spaced apart from the bottom wall of the cavities 79 (FIG. 16) and the peripheral wall 63 of the distal end cap 40 abuts the lateral wall 50b.

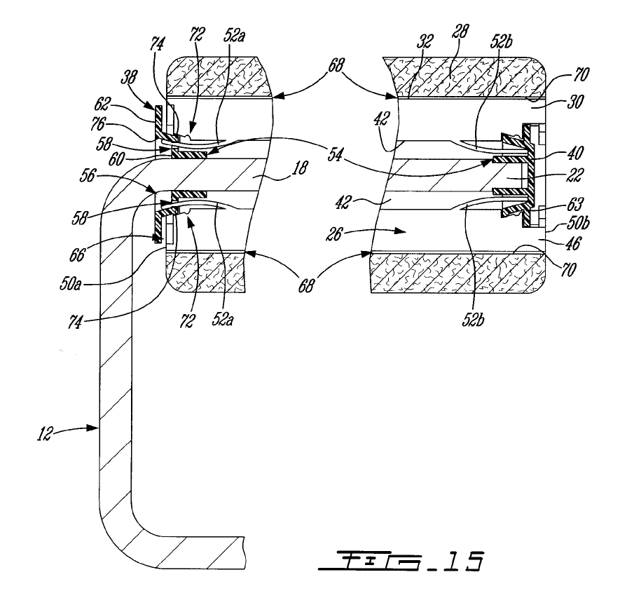

The tabs 52 have a substantially arcuate shape and they are made of a relatively flexible material. As mentioned above, the engaging groove 72 of each cage section 36 is defined to receive a section of the protruding member 74a (or male member) which is defined in the lateral wall 76 of the proximal end cap 38 and a section of the protruding member 74b defined in the distal end cap (see FIGS. 8 and 11 for more details). In the expanded configuration of the roller cage 26, the protruding members 74 are engaged in the engaging grooves 72 to maintain the roller cage 26 in the expanded (or operative) configuration as shown in FIGS. 14 and 16. In other words, they act as stoppers.

By pushing the roller cage 26 over the support rod 12 towards the proximal end cap 38 until the protruding members 74 engage the engaging grooves 72 and the inner surface 64 of the proximal end cap peripheral wall 62 abuts the lateral wall 50 of the cage 26, the roller cage 26 is configured from the first or contracted configuration into the second or expanded configuration. As shown in FIGS. 14 and 16, in the expanded configuration, the peripheral wall 62 is inserted in the cavity 49 defined by the roller sections 36 assembled together. The tabs 52 slide in the tab openings 58 and straighten, pushing outwardly the cage sections 36 defining the roller cage 26. Therefore, the diameter of the resulting roller cage 26 is larger in the expanded configuration than in the contracted configuration. From the contracted configuration to the expanded configuration, the diameter of the roller cage 26 expands from a smaller diameter (first diameter) to a larger diameter (second diameter). The outer surface 32 of the roller cage 26 abuts the inner wall 70 of a roller cover 28 extending over the cage and preventing the roller cover 28 from being easily withdrawn from the roller cage 26. In other words, it engages the roller cover 28 to the roller cage 26.

To disengage the roller cover 28 from the roller cage 26, the tabs 52 are pushed outwardly against the lateral walls 76 of the end cap depressions 56 and the roller cover and cage assembly is pulled towards the roller end 22 of the support rod 12. The protruding members 74 and the engaging grooves 72 are disengaged from one another. The tabs 52 slide inwardly in the tab openings 58. The cage sections 36 slide inwardly towards the rod member 12 thereby redefining the cylindrical free space 68 between the outer surface 32 of the cage 26 and the inner wall 70 of the roller cover 28. Therefore, the roller cover 28 can easily be removed or slid out from the roller cage 26.

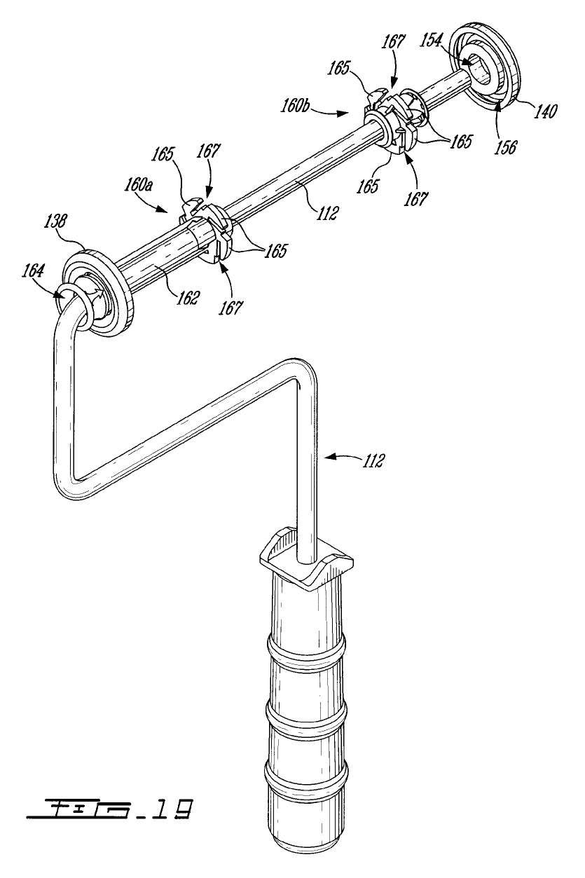

Now referring to FIGS. 17 to 24, there is shown an alternative embodiment of a paint roller 110 wherein the roller cage 126 has a different design and a different mechanism for being configurable in the expanded and contracted configurations. The features of this embodiment are numbered with reference numerals in the 100 series which correspond to the reference numerals of the previous embodiment.

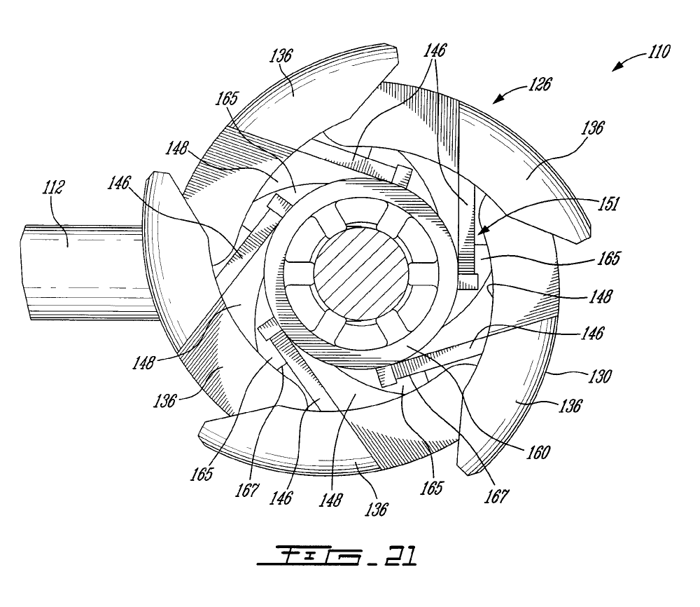

The barrel member 130 has five longitudinally extending cage sections 136, a proximal end cap 138, and a distal end cap 140. Both end caps 138, 140 connect the five cage sections 136 together to define the barrel member 130 with the cylindrical outer surface 132 and have a central channel 154 defined therein. As shown in FIG. 19, the support rod 112 is insertable in the channel 154 to mount to end caps 138, 140 thereto.

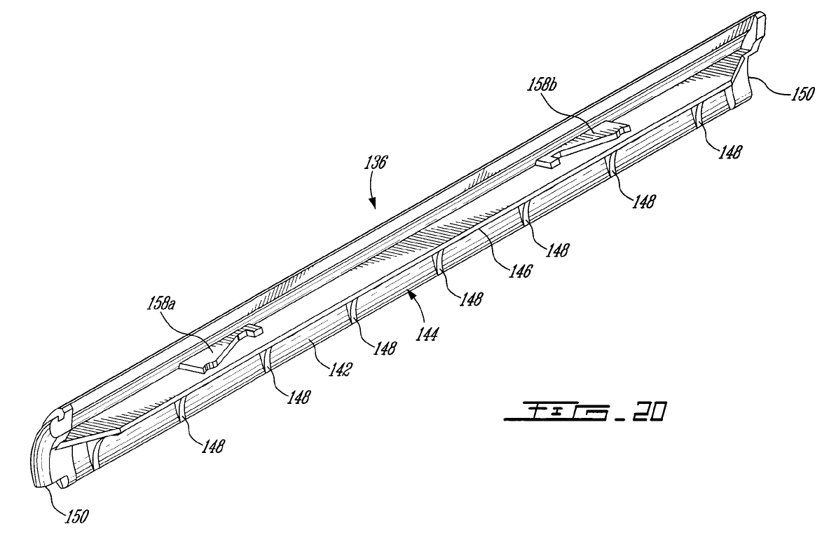

Referring to FIG. 20, there is shown that, as for the cage sections 36, each cage section 136 has an outer surface 132a, an opposite inner surface 142, and a web 144 protruding inwardly from the inner surface 142 to provide structural rigidity to the cage section 136, amongst others. The web 144 includes a longitudinally extending ridge 146 and a plurality of transversally extending ridges 148. In the embodiment shown, the longitudinal ridge 146 does not extend radially. It extends at a predetermined angle as it will be explained in more details below. Each cage section 136 has two opposite edges 150 insertable in an annular groove 156 of a corresponding one of the proximal end cap 138 and the distal end cap 140 when assembled together to define the barrel member 130 (FIG. 18). When the five cage sections 136 are assembled together to define the barrel member 130, a central opening 151 is defined centrally and extends from the distal end cap 140 to the proximal end cap 138.

Referring to FIG. 20, there is shown that each cage section 136 includes two spaced-apart abutting ramps 158a, 158b, juxtaposed to the longitudinal ridge 146. Each abutting ramp 158a, 158b has a lower section and an upper section with a ramp section extending therebetween. In the embodiment shown, the upper section of the proximal abutting ramp 158a is proximate to the proximal end cap 138 and the upper section of the distal abutting ramp 158b is proximate to the distal end cap 140. Thus, the ramp sections of both abutting ramps 158 are oriented in opposite directions. The opposed ends of the lower and upper sections of the abutting ramps 158a, 158b have stoppers or abutting members. The purpose of the abutting ramps 158a, 158b will be described in more details below.

Referring to FIGS. 18 and 19, there is shown that the paint roller 110 also includes two spaced apart rings 160a, 160b mounted to the support rod 112. The proximal ring 160a is connected to the proximal end cap 138 through a cylindrical cover member 162 having a central channel 164 extending therethrough. The proximal ring 160a and the proximal end cap 138 are respectively mounted at opposite ends of the cylindrical cover member 162. The support rod 112 extends through the central channel 164 of the cylindrical cover member 162. As it will be described in more details below, the cylindrical cover member 162 can slide over the support rod 112 between two configurations corresponding respectively to the expanded configuration and the contracted configuration of the roller cage 126.

The distal ring 160b is mounted at a predetermined and fixed position to the support rod 112, towards the distal end cap 140.

The design of the proximal and distal rings 160a, 160b is similar and only one will be described below. Each ring 160 includes five fingers 165, one for each cage section 136, extending outwardly in a substantially spiral shape. Each finger 165 is spaced apart from an adjacent finger 165 by a substantially straight slot 167. The fingers 165 and the slots 167 of the proximal ring 160a are in register with the fingers 165 and the slots 167 of the distal ring 160b.

The longitudinal ridge 146 of each cage section 136 is slidably insertable in a respective slot 167 of the rings 160a, 160b when the roller cover 126 is assembled. Thus, the barrel member 130 is maintained assembled by inserting the longitudinal ridges 146 of the cage sections 136 in a slot 167 of the rings 160a, 160b and the edges 150 of the cage sections 136 in the annular grooves 156 of the end caps 138, 140. When assembled, the tips of the fingers 165 abut a respective one of the abutting ramps 158a, 158b. The distal end cap 140 is secured to the support rod 112 while the proximal end cap 138 is slidably mounted to the support rod 112 through cylindrical cover member 162.

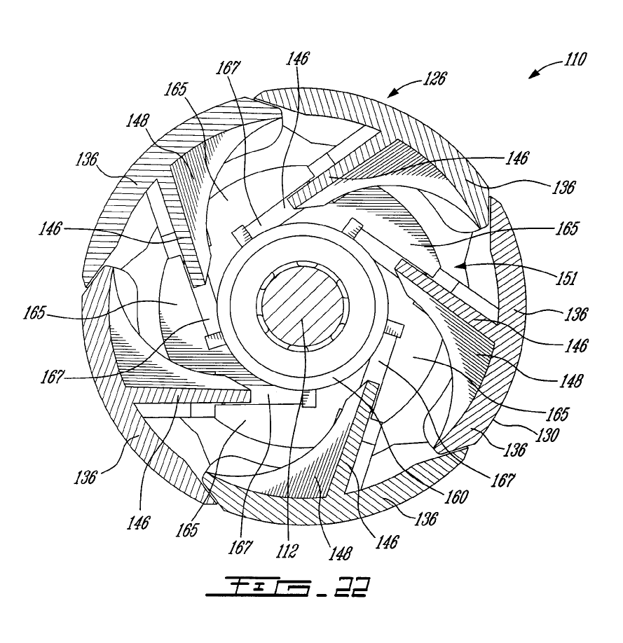

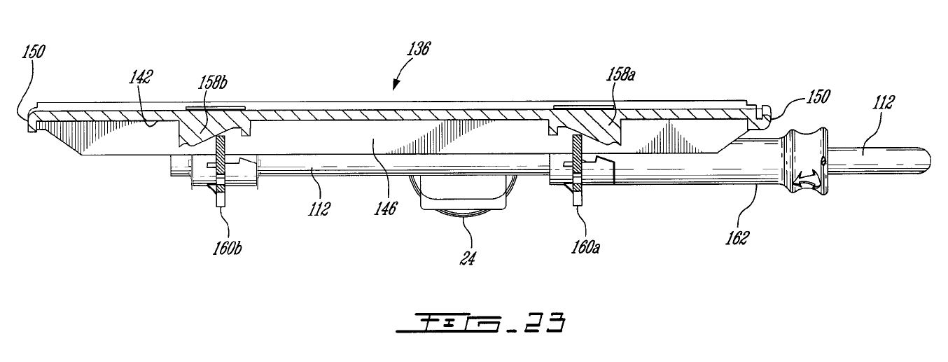

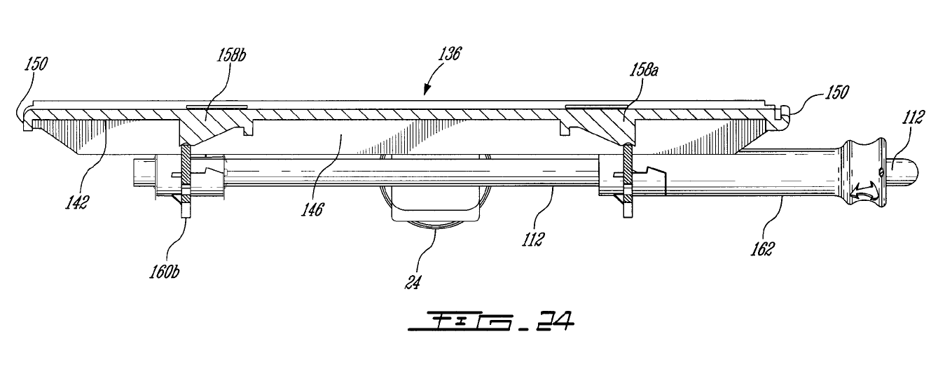

FIGS. 21 and 23 show the roller cage 126 in the storage configuration. The tips of the fingers 165 abut the lower sections of the abutting ramps 158a, 158b. Spaces are defined between the cage sections 136 and portions of adjacent cage sections 136 are overlapped. FIGS. 22 and 24 show the roller cage 126 in the operative configuration. The tip of the fingers 165 abuts the upper sections of the abutting ramps 158a, 158b. The longitudinal edges of cages sections 126 abut the longitudinal edges of the adjacent cages sections 136, thereby defining a substantially continuous outer surface with a cylindrical shape, as shown in FIG. 22. It is appreciated that the longitudinal edges of adjacent cage sections 136 can be slightly spaced-apart from one another. The external diameter of the roller cage 126 in the operative configuration is wider than in the storage configuration.

In both configurations, the support rod 112 extends centrally through the roller cage and cover assembly. The roller cover (not shown in FIGS. 21 to 24) can extend outwardly and surrounds the roller cage 126, mounted to the support rod 112. As shown, the support rod 112 is inserted in the cylindrical channels 154 of both end caps 138, 140.

For configurating the roller cage in the operative configuration (FIGS. 22 and 24) from the storage configuration (FIGS. 21 and 23), the cylindrical cover member 162 is pulled in a direction opposite from the roller end 22. The proximal ring 160 moves simultaneously with the cylindrical cover member 162 since it is mounted thereto. The finger tips of the proximal ring 160 slide from the lower section of the proximal abutting ramp 158a towards the upper section until they abut the stoppers located at the end of the upper section. The stoppers prevent further displacement of the fingers 165 relatively to the abutting member 158. The cage sections 136 remain stationary along the longitudinal axis during this first sliding movement of the cylindrical cover member 162. The barrel member 130 is then configured into an intermediate configuration between the contracted configuration and the expanded configuration. The cylindrical cover member 162 is further pulled in the direction opposite from the roller end 22. Since the finger tips of the proximal ring 160 abut the stoppers, the cage sections 136 and both end caps 138, 140 slide simultaneously with the cylindrical cover member 162 in the direction opposite from the roller end 22. The distal ring 160 being secured to the support rod 112, the finger tips of the distal ring 160 slide upwardly towards the upper section of the distal abutting ramp 158b until they abut the stoppers located at the end of the upper section. The barrel member 130 is then configured into the expanded configuration shown in FIGS. 22 and 24.

As mentioned above, the longitudinal ridges 146 and the corresponding slots 167 do not extend radially relatively to the center of the roller cage 126. They extend at an angle. Thus, in the contracted state, portions of two adjacent cage sections 136 are overlapped as shown in FIG. 21. When configurating the roller cage 126 into the expanded configuration from the contracted configuration, the cage sections 136 slide outwardly relatively to a central longitudinal axis of the roller cage 126, in the direction of the slots 167. In the expanded configuration, the longitudinal edges of the cage sections 136 are juxtaposed (slightly spaced-apart from one another or not) to define a substantially continuous outer surface having a substantially cylindrical shape as shown in FIG. 22.

For configurating the roller cage in the contracted configuration (FIGS. 21 and 23) from the operative configuration (FIGS. 22 and 24), a similar operation is performed in the reverse order. The cylindrical cover member 162 is pushed towards the roller end 22. The proximal ring 160a moves simultaneously with the cylindrical cover member 162 since they are mounted thereto. The finger tips of the proximal ring 160a slide from the upper section of the proximal abutting ramp 158a towards the lower section until they abut the stoppers located at the end of the lower section. The cage sections 136 remain stationary along the longitudinal axis during this first sliding movement of the cylindrical cover member 162. The barrel member 130 is then configured into an intermediate configuration between the contracted configuration and the expanded configuration. The cylindrical cover member 162 is further pushed towards the roller end 22. Since the finger tips of the proximal ring 160a abut the stoppers, the cage sections 136 and both end caps 138, 140 slide simultaneously with the cylindrical cover member 162 towards the roller end 22. The distal ring 160b being secured to the support rod 112, the finger tips of the distal ring 160b slide downwardly towards the lower section of the distal abutting ramp 158b until they abut the stoppers located at the end of the lower section. The barrel member 130 is then configured into the contracted configuration shown in FIGS. 21 and 23.

In the operative configuration of the paint roller 110, the end caps 138, 140 are disposed and fitted in the ends of the roller sections 136 for preventing paint from entering the hollow interior of the barrel member 130 or between the outer surface 132 of the cage 126 and an inner wall 70 of the roller cover 28. It is appreciated that, in an alternative embodiment (not shown), the paint roller cage can be end cap free, i.e. it does not include end caps. The cage sections 136 can be slidably mounted to the rings or other components of the paint roller cage assembly or the paint roller cage assembly can include a protective sleeve that maintains the cage sections assembled together as it will be described in more details below.

As for the above-described embodiment, in the contracted configuration, a narrow cylindrical free space is defined between the outer surface 132 of the roller cage 126 and the inner wall 70 of the roller cover 28, i.e. the outer diameter of the barrel member 130 is smaller than the diameter of the cylindrical channel 134. Therefore, the roller cover 28 can be easily slid in and slid out over the roller cage 126 in the contracted configuration. In the expanded configuration, the paint roller cover 28 is secured to the roller cage 126 having a larger diameter than in the contracted configuration.

It is appreciated that, in an alternative embodiment, the cylindrical cover member 162 can be located at the distal end with the distal ring 160b being mounted thereto. In that embodiment, the proximal ring 160a can be secured to the support rod 112.

In another alternative embodiment (not shown), both rings 160 are secured to the support rod 112 and the assembly is cylindrical cover member free. The slopes of both abutting ramps 158 are oriented in the same direction. Thus, for configurating the barrel member in the operative configuration from the storage configuration, the cage sections 136 are pushed from the lower section of the abutting ramps 158 towards the upper section. On the opposite, for configurating the roller cage in the contracted configuration from the operative configuration, a similar operation is performed in the reverse order. The cage sections 136 are pushed from the upper section of the abutting ramps 158 towards the lower section.

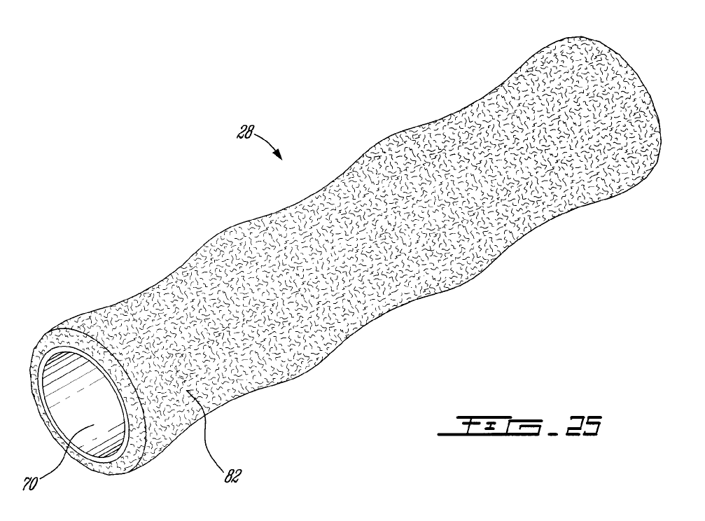

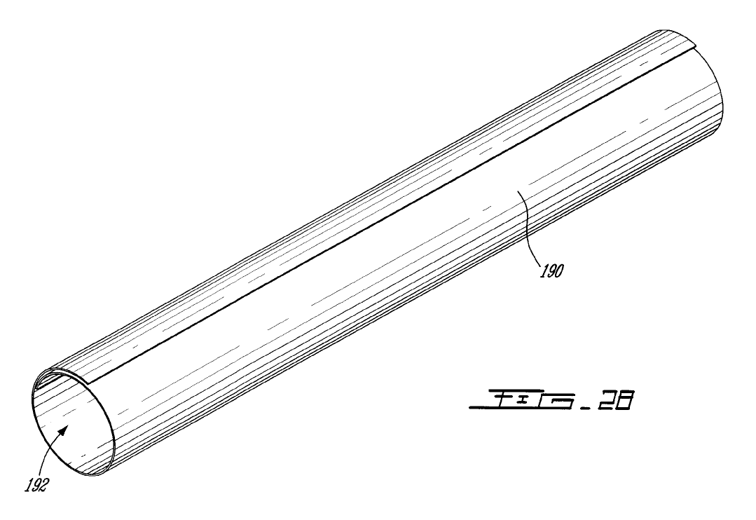

Referring now to FIGS. 25 to 27, the roller cover 28, which is flexible in the longitudinal and transversal axes, will be described. The roller cover 28 includes a flexible substrate 80, which defines the inner wall 70 of the cover 28, and outer circumferential surface material 82 mounted to the flexible substrate 80 and adapted for carrying paint or other material to be applied to the work surface.

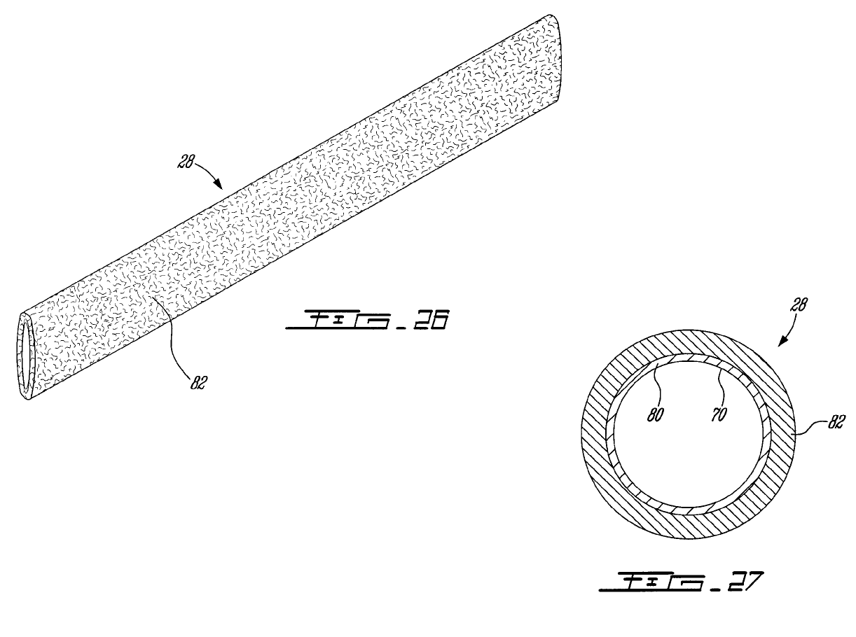

As shown in FIGS. 25 and 26, in an embodiment, the roller cover 28 is flexible in both the longitudinal and transversal directions. Therefore, it can be folded or rolled for storage and transport purposes. It can be wrung while cleaning for substantially rapidly removing paint and water.

The flexible substrate 80 can have elastic properties to ensure a tight engagement with the roller cage in the expanded configuration. Moreover, it can have water-repellent properties or it can include a barrier material layer to substantially prevent paint from being in contact with the outer surface of the roller cage. Furthermore, it can have a closed end (not shown), which abuts the distal end cap of the roller cage when mounted thereto, and include an elastic strap (not shown) at the opposed end, the elastic strap being juxtaposed to the proximal end cap of the roller cage when mounted thereto, the elastic strap substantially preventing paint infiltration between the roller cage and the roller cover. In an embodiment, the surface material 82 can be adhesively mounted to the flexible substrate 80.

The substrate material 80 can be a canvas, a flexible polymer or any other appropriate material, for instance. It can be made from either woven or non-woven materials.

The surface material 82 can be made of sponge, cotton, natural fibers, synthetic fibers, wool or the like and is highly capable of absorbing paint or other liquid to be applied.

The thickness of both the substrate material 80 and the surface material 82 can vary in accordance with the user's needs. In an embodiment, at least one of the substrate material 80 and the surface material 82 can be made of a recyclable material or a biodegradable material.

The roller cover 28 and the corresponding roller cage can have a width and a diameter substantially equally to those of standards 2, 4, and 9-inch roller, for instance. However, other widths and diameters may be used.

The support member and the roller cage can be made from any suitable materials, such as substantially rigid polymers, aluminum or steel, for instance.

The outer surface of the roller cage can be substantially smooth or it can include a protuberance pattern providing an improved adherence of the roller cover to the cage. In the embodiment shown, the barrel member is continuous in that it provides substantially continuous support to the roller cover mounted thereto for a substantially uniform paint application. The roller cage can include more or less cage sections.

Thus, flexible roller covers can be used in combination with a roller cage (or a roller cage adapter) having a substantially continuous, rigid, and cylindrical outer surface. The roller cage (or the adapter) provides a substantially continuous support to the flexible roller cover for application of paint or other similar substances. The roller cage (or the adapter) can be used with several roller covers. For instance, when a roller cover is worn, one can buy a new roller cover and use it with the same roller cage or adapter. Moreover, when applying two different paints (or similar substances), the same roller cage (or adapter) can be used with two different roller covers, each carrying a different paint.

Flexible roller covers are more ecologically friendly than traditional rigid roller covers since they do not include a rigid cylindrical member for maintaining the roller cover in a substantially cylindrical shape. Moreover, since they are foldable, rollable, and/or compactable, the shipping and the storage costs are reduced comparatively to traditional rigid roller covers.

It is appreciated that the roller cage and the roller cover can be provided independently or as a kit, i.e. a roller cage and cover assembly. The roller cover can also be provided as a kit with an adapter (not shown) for mounting the flexible roller cover to a conventional roller cage (not shown). The adapter can be movable between two configurations: a contracted configuration allowing relatively easily engaging and disengaging the roller cover from the latter and an expanded configuration wherein the roller cover is substantially firmly maintained over the adapter. In an embodiment, the adapter includes a roller cage engaging member for securing the adapter to the convention roller cage and a cylindrical and rigid outer surface providing continuous support to the roller cover mounted thereto.

Referring to FIG. 28, there is shown an embodiment of an adapter 190. The adapter 190 has a spiral shape with a central opening 192 defined therein. It can be made of a substantially rigid material, such as and without being limitative, polymers. The adapter is expandable to be mounted to the cage supporting frame of a conventional roller frame. For instance and without being limitative, it can be inserted over the longitudinal extending rods defining the cage supporting frame of a conventional roller frame to provide a substantially continuous and rigid outer surface to support the flexible roller cover. Due to its spiral shape, the adapter 190 is slightly expandable to be relatively easily inserted over the cage supporting frame and secured thereto. The outer surface of the adapter 190 can be substantially smooth or include a protuberance pattern providing an improved adherence of the roller cover to the adapter 190.

The adapter for mounting the flexible roller cover 28 to a conventional roller cage (not shown) can also be provided independently.

The roller cage and cover assembly can also include a protective sleeve configurable into a cylindrical shape and insertable over the barrel member, including or not the end caps. The protective sleeve can be made of a flexible and resilient material such as and without being limitative urethane and silicone. When inserted over the barrel member, it prevents paint insertion into the barrel member. It can entirely or partially cover the barrel member. Since it is made of a resilient material, it follows the shape of the barrel member between the expanded and contracted configurations. It can also be mounted over the adapters described above.

Thus, between the contracted and expanded configurations, the cage sections of the roller cage are slidable between two configurations. For instance, they can carry out a substantially radial, spiral or translation movement between both configurations. In the expanded configuration, they define a substantially continuous and rigid outer surface providing support to the paint cover for painting purposes.

As mentioned above, it is appreciated that the roller cage can be end cap free, i.e. it does not include end caps. For instance, if the roller cage and cover assembly includes a protective sleeve, the protective sleeve can maintain the cage sections together in an assembled configuration. Alternatively, the cage sections can be slidably mounted and secured to other members such as the rings 150 in the embodiment described above.

The roller painting kit can easily be stored and transported by reducing the necessary volume, i.e. the roller cage can be configured in the contracted position and the flexible roller cover can be folded. Moreover, the flexible roller cover can be wrung during a washing process.

The embodiments of the invention described above are intended to be exemplary only.

It is appreciated that, in an alternative embodiment, the roller cage and/or the roller cage adapter can have several expanded configurations, with different diameters, to receive thereon roller covers of different diameters, adapted in accordance with the painting task to be performed.

It is also appreciated that the mechanism to modify the roller cage and roller cage adapter diameter and the mechanism for maintaining the roller cage in the expanded configuration can vary from the ones described above. Moreover, the flexible roller cover can be engaged with the roller cage by a different mechanism than a cage diameter variation.

It is also appreciated that a traditional roll cover including a rigid cylindrical cage with a roller cover permanently mounted thereto can be mounted to the expandable roller cage described above.

The scope of the invention is therefore intended to be limited solely by the scope of the appended claims.

1. A paint roller cage for receiving a paint roller cover thereto, the paint roller cage comprising: a barrel member having an outer surface, a length corresponding substantially to a length of the paint roller cover, and being movable between a contracted state for engaging and disengaging the paint roller cover from the outer surface and an expanded state securing the paint roller cover to the barrel member.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A roller painting kit, comprising:
a cylindrical paint roller cage movable between a storage configuration and an operative configuration and having a plurality of adjacent cage sections defining a substantially cylindrical barrel member in the operative configuration; and
a roller cover slidable over the paint roller cage in the storage configuration and secured over the paint roller cage in the operative configuration.

15. (canceled)

16. A roller painting kit as claimed in claim 14, wherein portions of two adjacent cage sections are overlapped in the storage configuration.

17. A roller painting kit as claimed in claim 14, wherein the cage sections are displaceable relatively one to another.

18. A roller painting kit as claimed in claim 17, wherein the adjacent cage sections are one of radially displaceable between the storage configuration and the operative configuration and translatable when moving between the storage configuration and the operative configuration.

19. (canceled)

20. A roller painting kit as claimed in claim 14, wherein the adjacent cage sections have a narrow gap defined therebetween in the operative configuration.

21. A roller painting kit as claimed in claim 14, wherein the cage sections are removably mounted to a roller section of a support frame.

22. A roller painting kit as claimed in claim 14, wherein the barrel member has a substantially continuous and cylindrical outer surface in the operative configuration for supporting the paint roller cover along its length.

23. A roller painting kit as claimed in claim 14, wherein the barrel member has a first diameter in the storage configuration and a second diameter in the operative configuration, the first diameter being smaller than the second diameter.

24. A roller painting kit as claimed in claim 14, comprising a protective sleeve insertable over the barrel member and preventing paint infiltration therein.

25. A roller painting kit as claimed in claim 14, comprising a stopper securing the paint roller cage in the operative configuration when activated.

26. A roller painting kit as claimed in claim 14, wherein the roller cover comprises a cylindrical cover element defining a cylindrical channel for receiving therein the paint roller cage, the roller cover being flexible along at least one of a longitudinal axis and a transversal axis when disengaged from the paint roller cage.

27. (canceled)

28. (canceled)

29. A roller painting kit as claimed in claim 14, wherein the outer diameter of the barrel member in the operative configuration substantially corresponds to the inner diameter of a cylindrical channel of the roller cover.

30. A flexible paint roller cover mountable to a paint roller cage, comprising a cylindrical cover element defining a cylindrical channel for receiving therein the paint roller cage, the roller cover being flexible along at least one of a longitudinal axis and a transversal axis when disengaged from the paint roller cage.

31. (canceled)

32. (canceled)

33. A roller cover adapter for a paint roller having a roller section, the roller cover adapter comprising:
a barrel member securable to the roller section of the paint roller and configurable in a storage configuration allowing to slide a roller cover over an outer surface of the barrel member and remove the roller cover from the outer surface and an operative configuration securing the roller cover to the outer surface, the barrel member having a substantially continuous and cylindrical outer surface in the operative configuration for supporting the paint roller cover along its length.

34. A roller cover adapter as claimed in claim 33, wherein the barrel member comprises a plurality of adjacent cage sections with the barrel member being substantially cylindrical in the operative configuration.

35. (canceled)

36. (canceled)

37. (canceled)

38. (canceled)

39. (canceled)

40. A roller painting kit, comprising:
a roller cage adapter engageable over a roller section of a paint roller and having a substantially continuous and cylindrical outer surface when engaged over the roller section; and
a flexible roller cover insertable over the roller cage adapter and including a cylindrical cover element defining a cylindrical channel for receiving therein the roller cage adapter, the roller cover being flexible along at least one of a longitudinal axis and a transversal axis when disengaged from the roller cage adapter, the roller cage adapter providing a substantially continuous support to the roller cover when inserted therein.

41. A roller painting kit as claimed in claim 40, wherein the flexible roller cover is rollable onto itself for storage.

42. A roller painting kit as claimed in claim 40, wherein the flexible roller cover is rigid member free.

43. A roller painting kit as claimed in claim 40, wherein the roller cage adapter has a spiral shaped cross-section.
